(19) United States
(12) Patent Application Publication
(10) Pub. No.: US 2012/0268565 A1
(43) Pub. Date: Oct. 25, 2012

(54) Operating Assembly Including Observation Apparatus, The Use of Such an Operating Assembly, and an Operating Facility

(75) Inventor: Bertrand GUILLEMINOT, Villermain (FR)

(73) Assignee: MAQUET SAS, Ardon (FR)

(21) Appl. No.: 13/450,671

(22) Filed: Apr. 19, 2012

(30) Foreign Application Priority Data
Apr. 19, 2011 (FR) 1153393

(51) Int. Cl. H04N 5/225; H04N 13/02

(52) U.S. Cl. 348/46; 348/373; 348/E05.027; 348/E13.073

(57) ABSTRACT

An operating assembly, in particular for a medical operating field, comprises an operating lighting apparatus having a lighting support arm mounted on a support to be independently pivotally movable, and observation apparatus comprising a camera support arm mounted on support to be independently pivotally moveable, a camera module with a camera support mounted to be pivotally movable relative to the camera support arm and drive means for driving the camera support, and control means for controlling the drive means. The camera module comprises two observation cameras, each of which has a vision axis and a vision direction, each end of the camera support carrying a camera so that the cameras are disposed on either side of an axis of symmetry passing through the middle of the camera support.

### TECHNICAL FIELD

The present invention relates to an operating assembly comprising a support extending along a central axis, operating lighting apparatus, and observation apparatus, in particular for observing a medical operating field, the operating lighting apparatus having a lighting support arm mounted on the support to be pivotally movable about a pivot axis extending parallel to the central axis of the support, the observation apparatus comprising a camera support arm mounted at a first end on the support to be perpendicular to the central axis and to be pivotally moveable relative to the support about a pivot axis extending parallel to the central axis, the lighting support arm and the camera support arm being independent in pivotal movement, the observation apparatus further comprising a camera module comprising a camera support mounted on the end of the camera support arm that is opposite from said first end and to be pivotally movable relative to the camera support arm about a pivot axis extending parallel to the central axis, and drive means adapted to move the camera support relative to the support, and control means for controlling the drive means.

### PRIOR ART

Operating assemblies are known that include apparatus for observing a medical operating field, such apparatus including a support and an arm that is mounted to move relative to the support and on which a camera is disposed that is designed to film the operating field. Such a camera is disposed on an independent arm that must be manipulated by the medical team during the operation. That type of known apparatus therefore gives only limited access to spectators situated remotely, and does not enable the spectators to have a full view of the operating theater in which the observation apparatus is disposed.

In particular, Patent Document WO 00/69354 discloses an operating assembly as described above and designed to enable students to observe an operation remotely by means of the observation apparatus. Unfortunately, that single-camera assembly offers limited remote observation possibilities.

Patent Document U.S. Pat. No. 7,224,472 also discloses an operating assembly comprising a support, operating lighting apparatus, and observation apparatus. Unfortunately, that operating assembly, which is designed to view markers in three dimensions (3D), comprises cameras that are mechanically associated with the lighting so that the optical signals coming from the markers detected by the cameras can be evaluated in the shadow-free zone illuminated by the lighting apparatus. That operating assembly does not therefore make it possible for good remote observation to take place.

Finally, European Patent Document EP 0 672 389 discloses an operating assembly for localization on a patient, that assembly comprising a support, operating lighting apparatus, and observation apparatus. Unfortunately, in that operating assembly, the lighting support arm and the camera support arm constitute a single, common hinged arm, and the camera support arm is not drivable, thereby limiting remote observation.

### SUMMARY OF THE INVENTION

An object of the invention is to mitigate at least one of those drawbacks, and to propose an operating assembly with observation apparatus that enables a spectator situated remotely to have good visibility of the operating field during the operation. Preferably, the observation apparatus gives rise to little hindrance for the medical team during the operation, while also being easy to manipulate.

Another object is for the operating assembly with the observation apparatus to be inexpensive.

To these ends, the invention provides an operating assembly comprising a support extending along a central axis, operating lighting apparatus, and observation apparatus, in particular for observing a medical operating field, the operating lighting apparatus having a lighting support arm mounted on the support to be pivotally movable about a pivot axis extending parallel to the central axis of the support, the observation apparatus comprising a camera support arm mounted at a first end on the support to be perpendicular to the central axis and to be pivotally moveable relative to the support about a pivot axis extending parallel to the central axis, the lighting support arm and the camera support arm being independent in pivotal movement, the observation apparatus further comprising a camera module comprising a camera support mounted on the end of the camera support arm that is opposite from said first end and to be pivotally movable relative to the camera support arm about a pivot axis extending parallel to the central axis, and drive means adapted to move the camera support relative to the support, and control means for controlling the drive means, said operating assembly being characterized in that the camera module comprises two observation cameras, each of which has a vision axis and a vision direction, and in that the camera support is an arm fastened in its middle to the end of the camera support arm and each free end of the camera support carries an observation camera so that the observation cameras are disposed on either side of an axis of symmetry passing through the middle of the camera support.

In particular embodiments, the operating assembly may have one or more of the following characteristics:
the operating assembly further comprises two steering apparatuses controlled by the control means, each apparatus being adapted to steer one of the observation cameras about at least a first pivot axis relative to the camera support;
each steering apparatus is adapted to steer the observation camera about a second pivot axis perpendicular to the first pivot axis and to the vision axis;
the control means include a screen adapted to display the image sensed by at least one of the observation cameras, and preferably by both of the observation cameras;
the observation apparatus further comprises drive means controlled by the control means and adapted to move the camera support arm relative to the support and/or to move the camera support relative to the camera support arm;
the camera support is mounted to move relative to the camera support arm in pivoting about the axis through a given angular range;
the control means further comprise a control unit adapted to reconstruct in three dimensions the zone sensed by the two observation cameras;
the operating assembly has a configuration in which the vision axes of the observation cameras are parallel to each other and the vision directions are opposite to each other.
the control means further comprise a control unit adapted to synchronize the images simultaneously sent by each observation camera, so as to deliver an image in 3D to a spectator when the two observation cameras are observing the same common point of interest;
the observation apparatus defines a midplane that extends perpendicularly to the plane containing the two second pivot axes and parallel to the two second pivot axes, and that is situated half-way between said two second pivot axes, and said observation apparatus has a configuration in which the two observation cameras are observing the same common point of interest, and the midplane contains the common point of interest.

The invention also provides the use of an operating assembly of the invention, wherein the control means have a configuration in which each steering apparatus is controllable independently from each other by the control means.

The invention also provides the use of an operating assembly of the invention, wherein the vision axes of the observation cameras are parallel to each other and the vision directions are opposite to each other. As a variant, the camera support arm may occupy a stationary position.

The invention also provides the use of an operating assembly of the invention, wherein the apparatus defines a midplane that extends perpendicularly to the plane containing the two second pivot axes and parallel to the two second pivot axes, and that is situated half-way between said two second pivot axes, and the apparatus has a configuration in which the two observation cameras are observing the same common point of interest, and the midplane contains the common point of interest.

The invention also provides an operating facility comprising a medical operating theater and an operating assembly of the invention, wherein the observation cameras are installed in the medical operating theater, and in particular wherein at least some of the control means are situated outside the medical operating theater in which the observation cameras are installed.

### BRIEF DESCRIPTION OF THE DRAWINGS

The invention can be better understood on reading the following description, given merely by way of example and with reference to the accompanying drawings, in which:

FIG. 1 is a diagrammatic view of an operating facility including an observation apparatus of the invention, provided with a camera module; and

FIGS. 2 to 4 are detailed views of the camera module shown in FIG. 1, respectively in first, second, and third configurations.

### DESCRIPTION OF THE EMBODIMENTS

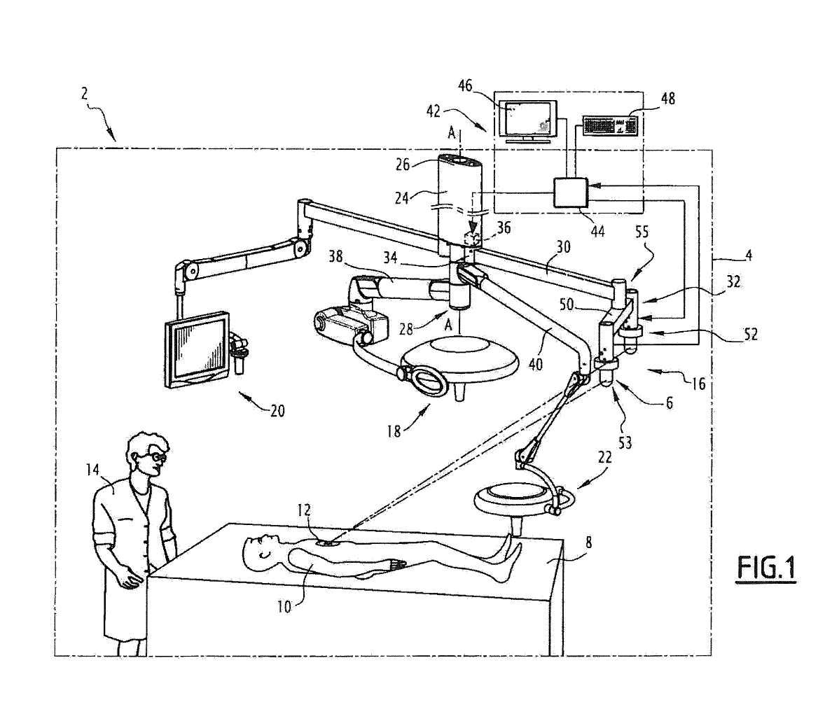

FIG. 1 shows an operating facility of the invention, given general reference 2. The operating facility 2 includes an operating theater 4 and an operating assembly 6. The operating facility 2 also includes an operating table 8.

On the operating table 8 there lies a patient 10 who defines a medical operating field 12. A surgeon 14 is standing in the vicinity of the patient 10 in such a manner as to operate on the operating field 12.

The operating assembly 6 includes observation apparatus 16 and main operating lighting apparatus 18. The operating assembly 6 also includes display apparatus 20 and secondary operating lighting apparatus 22.

The observation apparatus 16 includes a support 24 which is constituted by a post having a fastening end 26 and a free end 28. The support 24 extends along a central axis A-A. The fastening end 26 is fastened to a stationary structure, such as the ceiling of the operating theater 4 or the wall of said operating theater 4.

The observation apparatus 16 is equipped with a camera support arm 30 and with a camera module 32 that is described in detail below. The camera support arm 30 extends perpendicularly to the support 24 or to the central axis A-A.

The camera support arm 30 is movably mounted relative to the support 24, preferably so as to pivot about a pivot axis extending parallel to the central axis A-A of the support 24. The camera support arm 30 is preferably movable in pivoting exclusively about said pivot axis, i.e. it does not have any other degrees of freedom of pivoting relative to the support 24.

The pivotally mounted connection between the camera support arm 30 and the support 24 is formed by means of a hinge 34. Suitable drive means 36 make it possible to move the camera support arm 30 relative to the support 24. For example, these drive means 36 may be constituted by an electric motor.

The main operating lighting apparatus 18 and the secondary operating lighting apparatus 22 include respective lighting support arms 38 and 40, which arms are mounted to move relative to the support 24, preferably in pivoting about a pivot axis extending parallel to the central axis A-A of the support 24 or coinciding with said central axis A-A.

The camera support arm 30 is disposed closest to the fastening end 26, the lighting support arm 38 supporting the main operating lighting apparatus 18 is disposed closest to the free end 28, while the lighting support arm 40 supporting the secondary operating lighting apparatus 22 is disposed between the lighting support arm 38 and the camera support arm 30 along the central axis A-A. Thus, the movement of the lighting apparatuses 18, 22 is not hindered by the camera support arm 30.

In addition, the observation apparatus 16 includes control means 42 adapted to control firstly the camera module 32 and secondly the movement of the camera support arm 30 by controlling the drive means 36.

The control means 42 are remote from the support 24 and from the camera support arm 30.

The control means 42 include a control unit 44. The control unit 44 is connected to the drive means 36 and to the camera module 32 via control lines.

The control means 42 also include a screen 46 that is adapted to display or that displays the image or the images sensed by the camera module 32, as described in detail below. Preferably, the screen 46 is disposed outside the operating theater 4 in which the camera module 32 is installed.

The control unit 44 is connected to the screen 46 via a link connection adapted to transmit the images.

The control means 42 also include an input peripheral 48, e.g. a keyboard, adapted to input commands in order to control the camera module 32 and/or the movement of the camera support arm 30. Preferably, the input peripheral 48 is disposed outside the operating theater 4 in which the camera module 32 is installed. The control unit 44 is connected to the input peripheral 48 via a connection adapted to transmit the commands input via the input peripheral to the control unit 44.

There follows a description of the camera module 32.

The camera module 32 is disposed on one end of the camera support arm 30, which end is opposite from the end connecting to the support 24.

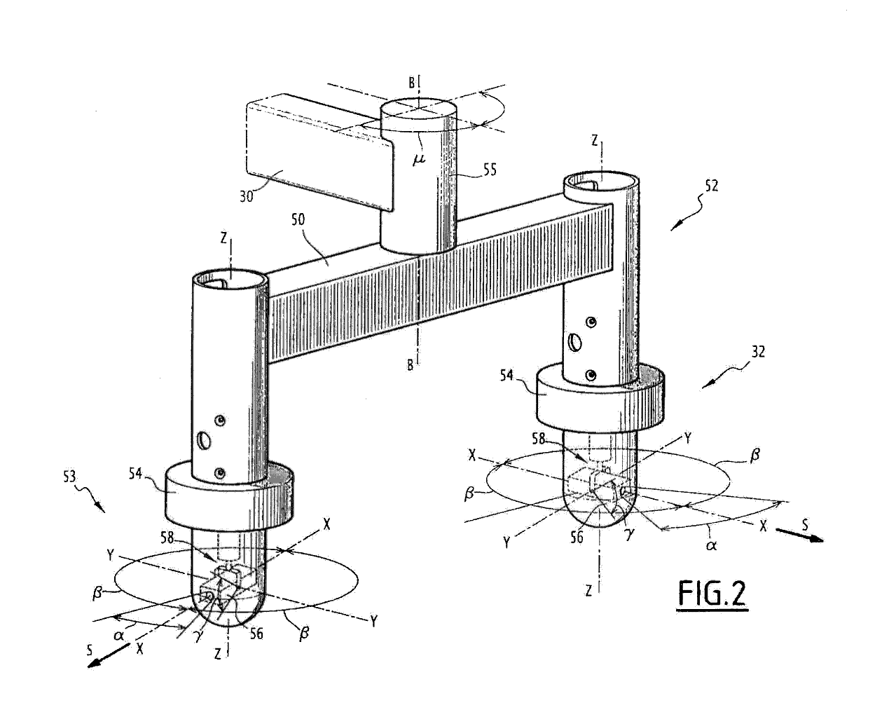

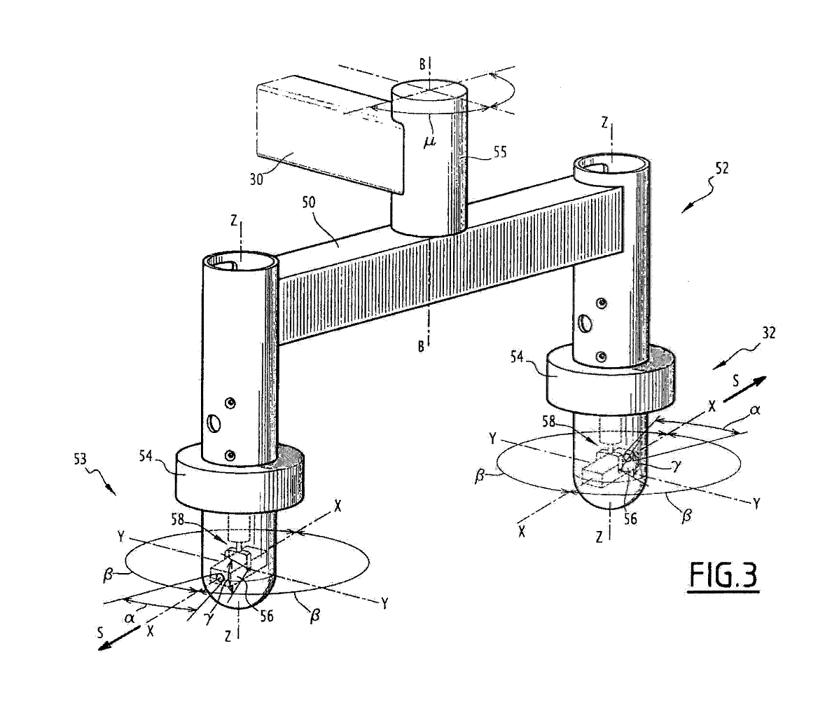

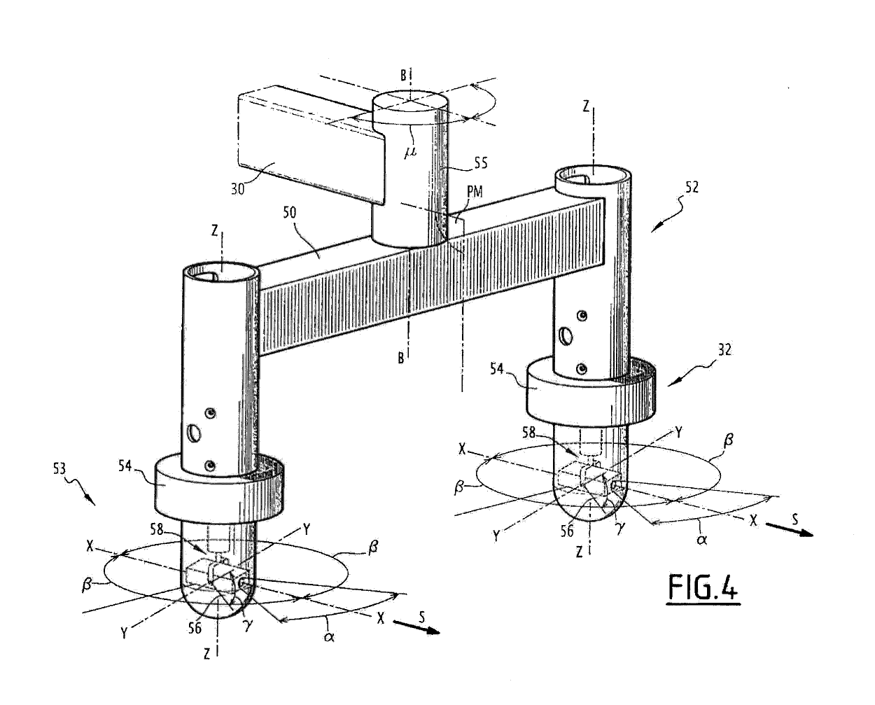

As can be seen in FIG. 2, the camera module 32 includes a camera support, which, in this example, is an arm 50 fastened at its middle to the end of the camera support arm 30. Each free end of the arm 50 carries vision apparatus 52 or 53. The vision apparatuses 52 and 53 are identical, and only one of them is described below.

Each vision apparatus 52, 53 comprises a housing 54 fastened to one end of the arm 50, an observation camera 56, and steering apparatus 58 adapted to move the observation camera 56 relative to the housing 54 and therefore relative to the arm 50.

The arm 50 is mounted to move relative to the camera support arm 30, preferably in pivoting about an axis B-B extending parallel to the central axis A-A of the support 24 and thus perpendicularly to the camera support arm 30. The arm 50 is preferably movable in pivoting exclusively about said pivot axis, i.e. it does not have any other degrees of freedom of pivoting relative to the camera support arm 30. The pivotally mounted connection between the arm 50 and the camera support arm 30 is formed by means of a hinge 55. Suitable drive means make it possible to move the arm 50 relative to the camera support arm 30. The arm 50 is hinged about the axis B-B in its main portion, preferably half-way between its ends.

A neutral position is defined for the arm 50, in which position the arm 50 extends perpendicularly to the camera support arm 30. The arm 50 is thus mounted to move through an angular range μ limited to +90° to −90° on either side of its neutral position.

Each observation camera 56 is disposed on either side of an axis of symmetry passing through the middle of the arm 50.

Each observation camera 56 defines a vision axis X-X and a vision direction S that coincides with the vision axis X-X.

The steering apparatus 58 is adapted to steer the observation camera 56 about a first pivot axis Y-Y. To this end, the steering apparatus 58 includes a drive motor for driving the camera about the axis Y-Y. The first pivot axis Y-Y is disposed perpendicularly to the vision axis X-X. The steering apparatus 58 is adapted to steer the observation camera about a second pivot axis Z-Z that is perpendicular to the first pivot axis Y-Y and to the vision axis X-X. To this end, the steering apparatus 58 includes a drive motor for driving the camera about the axis Z-Z. The axes X-X, Y-Y, and Z-Z define a common point of intersection.

The neutral position of the arm 50 or more generally of the camera support is defined by the position of the camera support, in which position the plane containing the two second pivot axes Z-Z belonging to the vision apparatuses 52 and 53 extends perpendicularly to the arm 30.

The steering apparatus 58 defines a neutral position for the observation camera 56. The steering apparatus 58 is adapted to turn the observation camera through an angular range β limited to +180° to −180° on either side of its neutral position relative to the axis Y-Y.

Similarly, the steering apparatus 58 is adapted to turn the observation camera through an angular range γ limited to +45° to −45° on either side of its neutral position relative to the axis Z-Z.

Each observation camera 56 has an angle of vision a lying in the range 30° to 90° and preferably lying in the range 40° to 60°. Also, the maximum zoom of the observation camera 56 indicated in focal distance lies in the range 3 millimeters (mm) to 180 mm, and in particular lies in the range 3.4 mm to 120 mm.

Preferably, the observation camera 56 is an Internet Protocol (IP) camera, i.e. a camera that is adapted to transmit data or the sensed image via an Internet Protocol (IP)/Transmission Control Protocol (TCP) link. The observation camera 56 is also controllable via an IP/TCP link. In particular, the zoom of the observation camera 56 is adjustable and controllable. Similarly, the drive motors for driving the camera about the axes Y-Y and Z-Z are preferably controllable via the IP/TCP link.

In addition, the camera module 32 may include a microphone (not shown) adapted to sense the sound inside the medical operating theater. Said microphone is preferably connected to the control means 42 and the control means 42 are adapted to transmit the sensed sound to a loudspeaker. To this end, the control means also transmit the sound via an IP/TCP link.

In a first configuration and in a first mode of use of this observation apparatus, the two observation cameras 56, which belong to respective vision apparatuses 52, 53, are used independently from each other, and thus enable a spectator looking at the screen 46 to observe two different views of the medical operating theater 4.

In this configuration and in this mode of use, the control means 42 are adapted to control the movement of the camera support arm 30 and the movement of the arm 50 supporting the vision apparatuses 52, 53. In this configuration, the direction of pointing and the zoom are controlled independently from one observation camera 56 to the other observation camera 56.

In other words, a command input via the input peripheral 48 and associated with one of the observation cameras is effective only for that camera, and does not control the other of the cameras.

In this mode, the screen 46 displays two independent images, each of which represents the image delivered by a respective one of the observation cameras 56. Two different views of the theater can thus be observed simultaneously by the camera module 32.

Thus, the spectator can see the medical operating field 12 better from two different viewpoints.

These two views or viewpoints can, in particular, be advantageous when the field of vision of one of the cameras is masked by a person present in the medical operating theater 4.

In a second configuration and in a second mode of use, the two observation cameras 56, which belong to respective vision apparatuses 52, 53, are pointed back-to-back in such a manner as to film opposite portions of the medical operating theater 4.

In this second configuration, the vision axes X-X of the two observation cameras 56 are parallel to each other and the vision directions are opposite to each other. Preferably, the two vision axes X-X coincide and are located in the plane containing the two pivot axes Z-Z.

In this mode of use, only the arm 50 is movable relative to the camera support arm 30 through the angular range μ.

Preferably, in this configuration, the position of the camera support arm 30 is stationary, i.e., once it is determined, the position of the camera support arm 30 is no longer modified. Similarly, once focusing has been performed, the steering apparatus 58 is no longer modified, which also means that the focal distance remains constant during implementation of this second configuration.

During focusing, the observation cameras 56 are set in such a manner as to film in opposite directions. To this end, once one of the observation cameras 56 has been positioned, the control means 42 position the other observation camera 56 correctly in the desired position.

In addition, for effective use of said second configuration, the control unit 44 has software adapted to reconstruct the medical operating theater 4 virtually in three dimensions, on the basis of the images filmed by the two observation cameras 56 and to generate a two-dimensional image.

By means of this mode of use, the spectator can then “move” virtually around the medical operating theater 4 without being present physically. By means of the input peripheral, the spectator can move around the reconstructed medical operating theater 4.

In a third configuration and in a third mode of use, the observation cameras 56 are used in “stereoscopic vision” mode. In this mode of use, the two observation cameras 56 observe a common point of interest which may, in particular, be the operating field 12 or a portion of said operating field.

In order to generate a stereoscopic image for the spectator, the observation cameras 56 must take up a position of stereoscopy relative to the point of interest. The apparatus defines a midplane PM that extends perpendicularly to a plane containing the axes Z-Z, that is parallel to the two axes Z-Z, and that is situated half-way between said two axes Z-Z. In the position of stereoscopy, the midplane PM contains the common point of interest. This condition avoids aberrations in the stereoscopic image delivered.

In this configuration, the user uses the input peripheral 48 to define the point of interest to be observed. The control unit 44 then controls the camera support arm 30 and/or the arm 50 and/or the steering apparatus 58 for the observation cameras 56 in such a manner that they are positioned in the position of stereoscopy as indicated above.

The user can always control the zoom of the cameras in order to obtain the desired view, close-up or far-away, of the point of interest.

The control unit 44 is adapted to synchronize the images received from each observation camera 56 in such a manner as to display on the screen 46 a single stereoscopic image showing the point of interest in 3D. To this end, the control unit 44 is provided with stereoscopy software that is adapted to combine the images simultaneously received from the observation cameras.

The stereoscopic image may be an anaglyph image, a polarized image, a time-shifted image, or any other stereoscopic image.

The three configurations and modes of use may be used by a single observation apparatus and implemented in a single observation apparatus, the spectators selecting the configuration and the mode in which they wish to use the observation apparatus.

In a variant, the camera support 50 of the observation apparatus of the invention may be fastened directly on the support 24. It is then preferably fastened in the vicinity of the free end 28 of said support 24. In this embodiment, the observation apparatus does not have the camera support arm 30 described above. The three configurations and modes of use described above may also be implemented by this variant.

The camera support 50 is then also mounted to be movable in pivoting relative to the support 24, preferably about the pivot axis B-B that is parallel to the central axis A-A. More particularly, the pivot axis B-B coincides with the central axis A-A. The pivotal mobility relative to the support is, once again, obtained by a hinge 55.

The observation apparatus of the invention is thus adapted to enable a spectator to inspect the medical operating field remotely, and to enable the camera module 32 or the camera support arm 30 to be moved independently without it being necessary for the surgical team to take any action, it then being possible for said surgical team to concentrate on the surgical operation.

1. An operating assembly comprising a support (24) extending along a central axis (A-A), operating lighting apparatus (18, 22), and observation apparatus (16), in particular for observing a medical operating field, the operating lighting apparatus (18, 22) having a lighting support arm (38, 40) mounted on the support (24) to be pivotally movable about a pivot axis extending parallel to the central axis (A-A) of the support (24), the observation apparatus (16) comprising a camera support arm (30) mounted at a first end on the support (24) to be perpendicular to the central axis (A-A) and to be pivotally moveable relative to the support (24) about a pivot axis extending parallel to the central axis (A-A), the lighting support arm (38, 40) and the camera support arm (30) being independent in pivotal movement, the observation apparatus (16) further comprising a camera module (32) comprising a camera support (50) mounted on the end of the camera support arm (30) that is opposite from said first end and to be pivotally movable relative to the camera support arm (30) about a pivot axis (B-B) extending parallel to the central axis (A-A), and drive means adapted to move the camera support (50) relative to the support (24), and control means (42) for controlling the drive means, said operating assembly being characterized in that the camera module (32) comprises two observation cameras (56), each of which has a vision axis (X-X) and a vision direction (S), and in that the camera support (50) is an arm fastened in its middle to the end of the camera support arm (30) and each free end of the camera support (50) carries an observation camera (56) so that the observation cameras (56) are disposed on either side of an axis of symmetry passing through the middle of the camera support (50).

2. An operating assembly according to claim 1, characterized in that it further comprises two steering apparatuses (58) controlled by the control means (42), each apparatus being adapted to steer one of the observation cameras (56) about at least a first pivot axis (Y-Y) relative to the camera support (50).

3. An operating assembly according to claim 2, characterized in that each steering apparatus (58) is adapted to steer the observation camera about a second pivot axis (Z-Z) perpendicular to the first pivot axis (Y-Y) and to the vision axis (X-X).

4. An operating assembly according to any preceding claim, characterized in that the control means (42) include a screen (46) adapted to display the image sensed by at least one of the observation cameras (56), and preferably by both of the observation cameras (56).

5. An operating assembly according to any preceding claim, characterized in that the observation apparatus (16) further comprises drive means controlled by the control means (42) and adapted to move the camera support arm (30) relative to the support (24) and/or to move the camera support (50) relative to the camera support arm (30).

6. An operating assembly according to any preceding claim, characterized in that the camera support (50) is mounted to move relative to the camera support arm (30) in pivoting about the axis (B-B) through a given angular range (μ).

7. An operating assembly according to any preceding claim, characterized in that the control means (42) further comprise a control unit (44) adapted to reconstruct in three dimensions the zone sensed by the two observation cameras (56).

8. An operating assembly according to claim 7, characterized in that it has a configuration in which the vision axes (X-X) of the observation cameras (56) are parallel to each other and the vision directions (S) are opposite to each other.

9. An operating assembly according to any preceding claim, characterized in that the control means (42) further comprise a control unit (44) adapted to synchronize the images simultaneously sent by each observation camera (56), so as to deliver an image in 3D to a spectator when the two observation cameras (56) are observing the same common point of interest.

10. An operating assembly according to claim 3 and claim 9, characterized in that the observation apparatus (16) defines a midplane (PM) that extends perpendicularly to the plane containing the two second pivot axes (Z-Z) and parallel to the two second pivot axes (Z-Z), and that is situated half-way between said two second pivot axes (Z-Z), and in that said observation apparatus has a configuration in which the two observation cameras (56) are observing the same common point of interest, and the midplane contains the common point of interest.

11. The use of an operating assembly according to claim 2, combined with any preceding claim, wherein the control means (42) have a configuration in which each steering apparatus (58) is controllable independently from each other by the control means (42).

12. The use of an operating assembly according to claim 7 or claim 8, wherein the vision axes (X-X) of the observation cameras (56) are parallel to each other and the vision directions (S) are opposite to each other.

13. The use of an operating assembly according to claim 12, wherein the camera support arm (30) occupies a stationary position.

14. The use of an operating assembly according to claim 3 and to claim 9 or claim 10, wherein the apparatus defines a midplane (PM) that extends perpendicularly to the plane containing the two second pivot axes (Z-Z) and parallel to the two second pivot axes (Z-Z), and that is situated half-way between said two second pivot axes (Z-Z), and the apparatus has a configuration in which the two observation cameras (56) are observing the same common point of interest, and the midplane contains the common point of interest.

15. An operating facility (2) comprising a medical operating theater (4) and an operating assembly according to any one of claims 1 to 10, wherein the observation cameras (56) are installed in the medical operating theater (4), and in particular wherein at least some of the control means (42) are situated outside the medical operating theater (4) in which the observation cameras (56) are installed.
